(19) United States
(12) Patent Application Publication
(10) Pub. No.: US 2013/0176426 A1
(43) Pub. Date: Jul. 11, 2013

(54) IMAGE SENSOR, METHOD OF SENSING IMAGE, AND IMAGE CAPTURING APPARATUS INCLUDING THE IMAGE SENSOR

(71) Applicants: Ilia Ovsiannikov, Studio City, CA (US); Pravin Rao, San Jose, CA (US)

(72) Inventors: Ilia Ovsiannikov, Studio City, CA (US); Pravin Rao, San Jose, CA (US)

(21) Appl. No.: 13/347,019

(22) Filed: Jan. 10, 2012

(51) Int. Cl. H04N 7/18

(52) U.S. Cl. 348/135; 348/E07.085

(57) ABSTRACT

The image sensor for sensing an image of an object by receiving reflected light obtained after output light is reflected by the object includes a pixel array that includes color pixels and depth pixels which receive the reflected light and a shuttering unit that facilitates outputting of color pixel signals by resetting the color pixels in units of a color integration time and reading the color pixels in units of the color integration time, and facilitates outputting depth pixel signals by resetting the depth pixels in units of a depth integration time, different from the color integration time, and reading the depth pixels in units of the depth integration time.

### BACKGROUND

1. Field

Embodiments relate to an image sensor, a method of sensing an image, and an image capturing apparatus including the image sensor, and more particularly, to an image sensor which may improve the quality of a sensed image, a method of sensing an image, and an image capturing apparatus including the image sensor.

2. Description of the Related Art

Technology related to imaging apparatuses and methods of capturing images has advanced at high speed. In order to sense more accurate image information, image sensors have been developed to sense depth information as well as color information of an object.

### SUMMARY

Embodiments provide an image sensor that may accurately sense an image of an object, a method of sensing an image, and an image capturing apparatus including the image sensor.

Embodiments are directed to providing an image sensor for sensing an image of an object by receiving reflected light obtained after output light is reflected by the object. The image sensor may include a pixel array having color pixels and depth pixels which receive the reflected light, and a shuttering unit that facilitates generation of color pixel signals by resetting the color pixels in units of a color integration time and reading the color pixels in units of the color integration time, and facilitates generation of depth pixel signals by resetting the depth pixels in units of a depth integration time, different from the color integration time, and reading the depth pixels in units of the depth integration time.

The shuttering unit may include a first reset unit that resets the color pixels and a second reset unit that resets the depth pixels.

The shuttering unit may be a rolling shutter that performs the resetting and the reading in units of rows of the pixel array.

The color integration time may be a time taken, after color pixels of an arbitrary row of the pixel array are reset, to read the color pixels of the arbitrary row. The depth integration time may be a time taken, after depth pixels of an arbitrary row of the pixel array are reset, to read the depth pixels of the arbitrary row.

The image sensor may further include a color information calculator that calculates the color pixel signals as color information of the object.

The image sensor may include a sample module that samples the depth pixel signals from depth pixels of an arbitrary row of the pixel array, and after the depth integration time elapses, samples the color pixel signals from the color pixels and the depth pixels of the arbitrary row.

The image sensor may further include a depth information calculator that estimates a delay between the output light and the reflected light from the depth pixel signals and calculates depth information of the object.

The image sensor may be a time-of-flight (TOF) sensor.

Embodiments are directed to providing a method of sensing an image of an object by receiving reflected light that is obtained after output light is reflected by the object. The method may including outputting the reflected light sensed by color pixels of a pixel array of the image sensor for a color integration time as color pixel signals, outputting the reflected light sensed by depth pixels of the pixel array for a depth integration time, different from the color integration time, as depth pixel signals, and calculating the color pixel signals and the depth pixel signals as image information of the object.

Outputting the color pixel signals may include resetting the color pixels in units of the color integration time and reading the reset color pixels in units of the color integration time.

Outputting the depth pixel signals may include resetting the depth pixels in units of the depth integration time and reading the reset depth pixels in units of the depth integration time.

Embodiments are directed to providing an image capturing apparatus including a light source that emits light, a lens that receives reflected light obtained after the light emitted from the light source is reflected by an object, an image sensor that senses image information of the object from the reflected light transmitted by the lens, and a processor that controls the image sensor and processes the image information transmitted from the image sensor. The image sensor may include a pixel array having color pixels and depth pixels which receive the reflected light, and a shuttering unit that facilitates generation of color pixel signals by resetting the color pixels in units of a color integration time and reading the reset color pixels in units of the color integration time, and facilitates generation of depth pixel signals by resetting the depth pixels in units of a depth integration time, different from the color integration time, and reading the reset depth pixels in units of the depth integration time.

Embodiments are directed to providing an image sensor for sensing an image of an object by receiving reflected light that is obtained after output light is reflected by the object. The image sensor may include a pixel array having first pixels and second pixels that sense different wavelengths of the reflected light and an integration control unit that reads the first pixels in units of a first integration time and reads the second pixels in units of a second integration time, different from the first integration time.

The first pixels may be color pixels sensing visible light and the second pixels may be depth pixels.

The depth pixels may output a plurality of depth pixel signals for each frame.

The depth pixels may sense infrared light.

### BRIEF DESCRIPTION OF THE DRAWINGS

Features will become apparent to those of ordinary skill in the art by describing in detail exemplary embodiments with reference to the attached drawings, in which:

FIG. 1 illustrates a block diagram of an image sensor according to an embodiment of the inventive concept;

FIGS. 2A and 2B illustrate diagrams for explaining an operation of the image sensor of FIG. 1;

FIGS. 3A and 3B illustrate diagrams of pixels of a pixel array of the image sensor of FIG. 1;

FIG. 4 illustrates a diagram of modulation signals used to sense an image in the image sensor of FIG. 1;

FIGS. 5A through 5E illustrate diagrams for explaining an operation of a shuttering unit of the image sensor of FIG. 1, according to an embodiment of the inventive concept;

FIGS. 6A through 6E illustrate diagrams of an operation of the shuttering unit of the image sensor of FIG. 1, according to another embodiment of the inventive concept;

FIGS. 7 and 8 illustrate diagrams of examples where color pixel signals and depth pixel signals of the image sensor of FIG. 1 are read, respectively;

FIG. 9 illustrates a block diagram of an image capturing apparatus according to an embodiment of the inventive concept;

FIG. 10 illustrates a block diagram of an image processing system according to an embodiment of the inventive concept; and

FIG. 11 illustrates a block diagram of a computing system according to an embodiment of the inventive concept.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

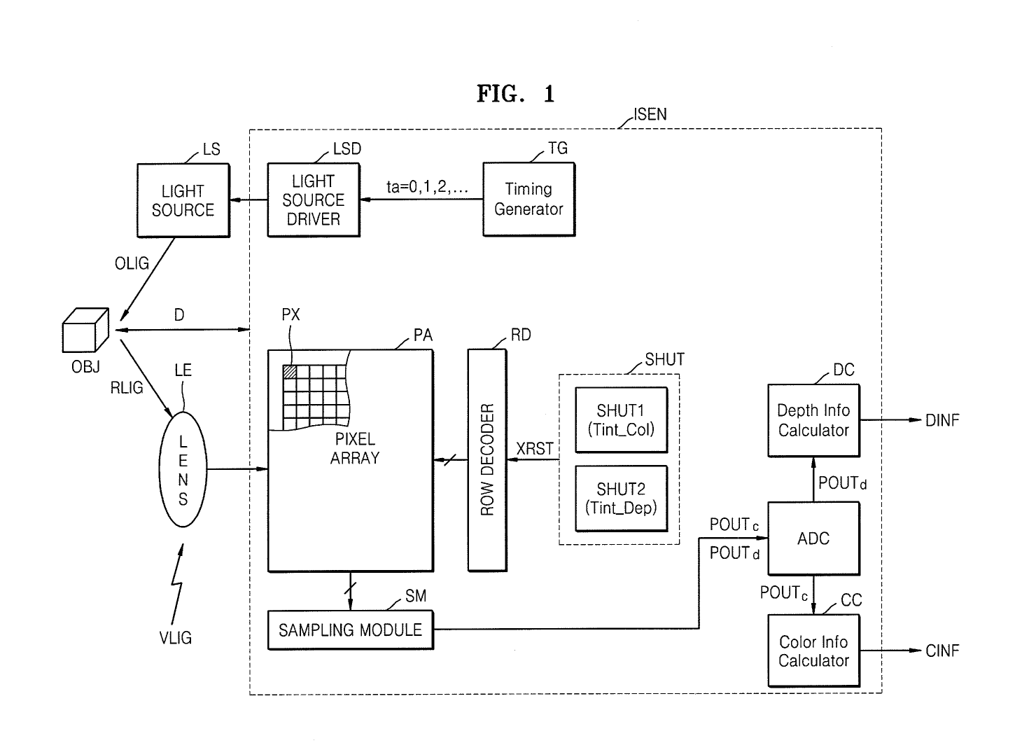

FIG. 1 illustrates a block diagram of an image sensor ISEN according to an embodiment of the inventive concept.

Referring to FIG. 1, the image sensor ISEN includes a pixel array PA, a timing generator TG, a row driver RD, a sampling module SM, an analog-to-digital converter ADC, a color information calculator CC, a depth information calculator DC, and a shuttering unit SHUT. The image sensor ISEN may be a time-of-flight (TOF) image sensor that senses image information (color information CINF and depth information DINF) of an object OBJ.

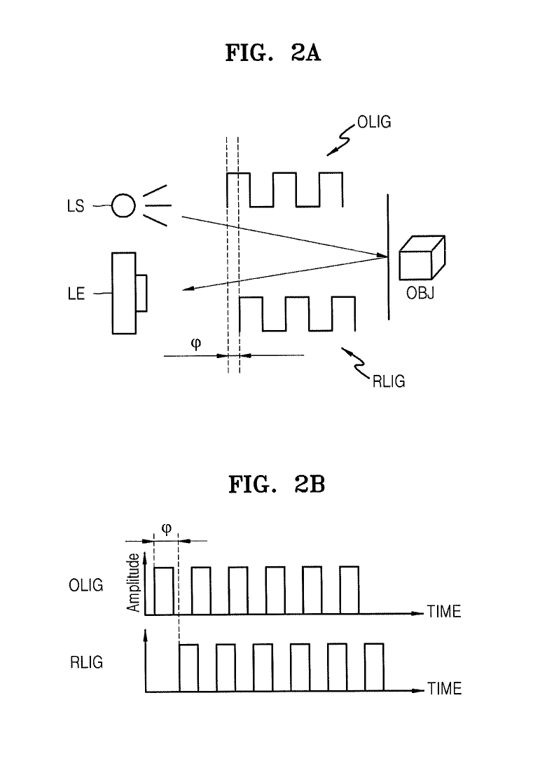

As shown in detail in FIG. 2A, the image sensor ISEN senses depth information DINF of the object OBJ from reflected light RLIG received through a lens LE after output light OLIG emitted from a light source LS has been incident thereon. In this case, as shown in FIG. 2B, the output light OLIG and the reflected light RLIG may have periodical waveforms shifted by a phase delay of φ relative to one another. The image sensor ISEN senses color information CINF from the visible light VLIG of the object OBJ.

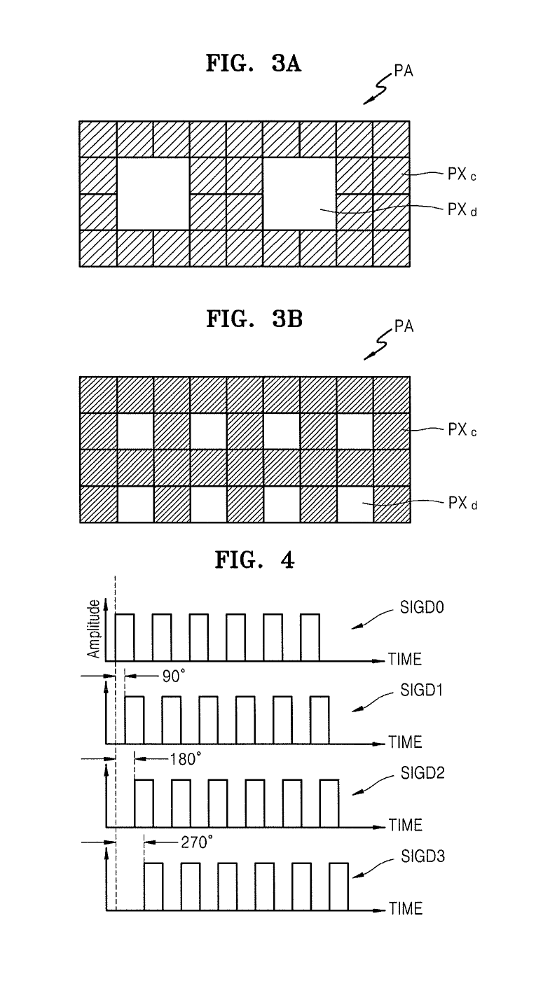

Referring again to FIG. 1, the pixel array PA includes a plurality of pixels PX arranged at intersections of rows and columns. The pixel array PA may include the pixels PX arranged in various ways. For example, as illustrated in FIG. 3A, while depth pixels PXd are larger in size than color pixels PXc, the depth pixels PXd may be smaller in number than the color pixels PXc. Alternatively as illustrated in FIG. 3B, the depth pixels PXd and the color pixels PXc may be the same size, and the depth pixels PXd may be smaller in number than the color pixels PXc. In the particular configuration illustrated in FIG. 3B, the depth pixels PXd and the color pixels PXc may be alternately arranged in alternate rows, i.e., a row may contain all color pixels PXc followed by a row containing alternating color pixels PXc and depth pixels PXd. The depth pixels PXd may sense infrared light of the reflected light RLIG.

Although the color pixels PXc and the depth pixels PXd are separately arranged in FIGS. 3A and 3B, embodiments are not limited thereto. The color pixels PXc and the depth pixels PXd may be integrally arranged.

The depth pixels PXd may each include a photoelectric conversion element (not shown) for converting the reflected light RLIG into an electric change. The photoelectric conversion element may be a photodiode, a phototransistor, a photo-gate, a pinned photodiode, and so forth. Also, the depth pixels PXd may each include transistors connected to the photoelectric conversion element. The transistors may control the photoelectric conversion element or output an electric change of the photoelectric conversion element as pixel signals. For example, read-out transistors included in each of the depth pixels PXd may output an output voltage corresponding to reflected light received by the photoelectric conversion element of each of the depth pixels PXd as pixel signals. Also, the color pixels PXc may each include a photoelectric conversion element (not shown) for converting the visible light into an electric charge. A structure and a function of each pixel will not be explained in detail for clarity.

If the pixel array PA of the present embodiment separately includes the color pixels PXc and the depth pixels PXd as shown in FIGS. 3A and 3B, pixel signals may be divided into color pixel signals POUTc output from the color pixels PXc and used to obtain color information CINF, and depth pixel signals POUTd output from the depth pixels PXd and used to obtain depth information DINF.

Referring again to FIG. 1, the light source LS is controlled by a light source driver LSD that may be located inside or outside the image sensor ISEN. The light source LS may emit the output light OLIG modulated at a time (clock) ‘ta’ applied by the timing generator TG. The timing generator TG may also control other components of the image sensor ISEN, e.g., the row decoder RD, the shuttering unit SHUT, etc.

The timing generator TG controls the depth pixels PXd to be activated so that the depth pixels PXd of the image sensor ISEN may demodulate from the reflected light RLIG synchronously with the clock ‘ta’. The photoelectric conversion element of each the depth pixels PXd outputs electric charges accumulated with respect to the reflected light RLIG for a depth integration time Tint_Dep as depth pixel signals POUTd. The photoelectric conversion element of each the color pixels PXc outputs electric charges accumulated with respect to the visible light for a color integration time Tint_Col as color pixel signals POUTc. A detailed explanation of the color integration time Tint_Col and the depth integration time Tint_Dep will be made with reference to the shuttering unit SHUT.

The depth pixel signals POUTd of the image sensor ISEN are output to correspond to a plurality of demodulated optical wave pulses from the reflected light RLIG which includes modulated optical wave pulses. For example, FIG. 4 illustrates a diagram of modulated signals used to illuminate an image in the image sensor ISEN of FIG. 1. Referring to FIG. 4, each of the depth pixels PXd may receive a demodulated signal, for example SIGD0, and illumination by four modulated signals SIGD0 through SIGD3 whose phases are shifted respectively by 0, 90, 180, and 270 degrees from the output light OLIG, and output corresponding depth pixel signals POUTd. The resulting depth pixel outputs for each captured frame are designated correspondingly as A0, A1, A2 and A3. Also, the color pixels PXc receive illumination by the visible light and output corresponding color pixel signals POUTc. Alternatively, referring to FIG. 4, each of the depth pixels PXd may receive illumination by one modulated signal only, for example SIGD0, while the demodulation signal phase changes from SIGD0 to SIGD3 to SIGD2 to SIGD1. The resulting depth pixel outputs for each captured frame are also designated correspondingly as A0, A1, A2 and A3.

Referring back to FIG. 1, the sampling module SM samples depth pixel signals POUTd from the depth pixels PXd and sends the depth pixel signals POUTd to the analog-to-digital converter ADC. Also, the sampling module SM such color pixel signals POUTc from the color pixels PXc and sends the color pixel signals POUTc to the analog-to-digital converter ADC. The analog-to-digital converter ADC converts the pixel signals POUTc and POUTd each having an analog voltage value into digital data. Even though the sampling module SM or the analog-to-digital converter ADC operates at the different time for the color pixel signals POUTc and the depth pixel signals POUTd, the image sensor may output the color information CINF in synchronization with the depth information DINF. For example, the sampling module SM may read out the pixel signals POUTc and POUTd simultaneously.

The color information calculator CC calculates the color information CINF from the color pixel signals POUTc converted to digital data by the analog-to-digital converter ADC.

The depth information calculator DC calculates the depth information DINF from the depth pixel signals POUTd=A0 through A3 converted to digital data by the analog-to-digital converter ADC. In detail, the depth information calculator DC estimates a phase delay φ between the output light OLIG and the reflected light RLIG as shown in Equation 1, and determines a distance D between the image sensor ISEN and the object OBJ as shown in Equation 2.

$$\begin{matrix}ϕ = arc tan ( \frac{{A}_{3} - {A}_{1}}{{A}_{2} - {A}_{0}} ) & [ Equation 1 ] \\ D = \frac{c}{4 \cdot F m \cdot π} * ϕ & [ Equation 2 ]\end{matrix}$$

In Equation 2, the distance D between the image sensor ISEN and the object OBJ is a value measured in meters, Fm is a modulation wave period measured in seconds, and ‘c’ is the speed of light. Thus, the distance D between the image sensor ISEN and the object OBJ may be sensed as the depth information DINF from the depth pixel signals POUTd output from the depth pixels PXd of FIG. 3 with respect to the reflected light RLIG of the object OBJ.

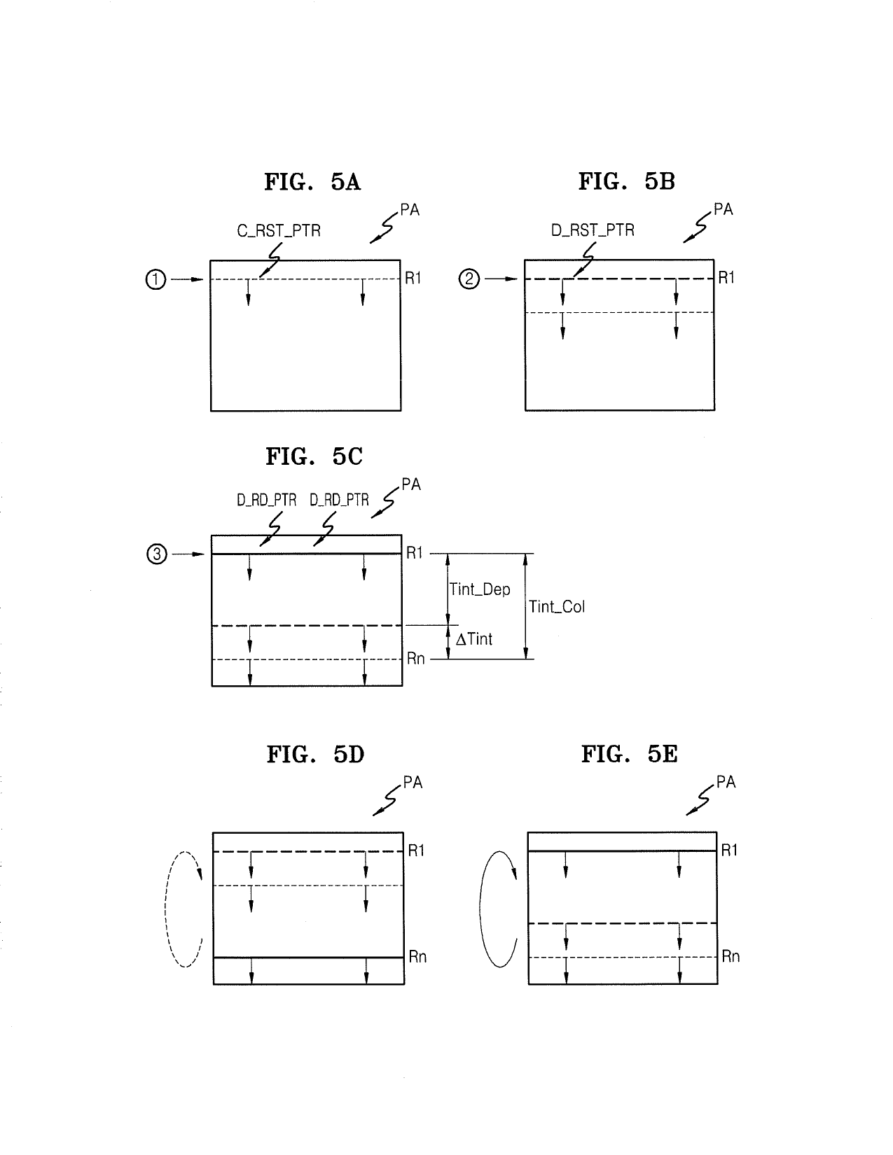

Still referring to FIG. 1, the shuttering unit SHUT may operate as a rolling shutter as shown in FIGS. 5A through 5E. The shuttering unit SHUT may send a reset signal XRST to the row decoder RD. The reset signal may indicate a row address regarding a row to be reset. The row decoder RD may sequentially perform resetting the pixel array PA from a first row R1 to a last row Rn in units of rows in response to the reset signal XRST.

The shuttering unit SHUT may include a first reset unit SHUT1 and a second reset unit SHUT2. The first reset unit SHUT1 may sequentially perform resetting on the color pixels PXc of each row. The second reset unit SHUT2 may sequentially perform resetting on the depth pixels PXd of each row. In this case, the color integration time Tint_Col and the depth integration time Tint_Dep may be different from each other.

FIGS. 5A through 5E illustrate diagrams for explaining an operation of the shuttering unit SHUT of the image sensor ISEN of FIG. 1, according to an embodiment of the inventive concept. FIGS. 5A to 5c illustrate an example where the color integration time Tint_Col is longer than the depth integration time Tint_Dep. As shown in FIGS. 5A through 5B, after a predetermined time after the first reset unit SHUT1 first resets the first row R1, designated as C_RST_PTR (\textcircled{1}), the second reset unit SHUT2 resets the first row R1, designated as D_RST_PTR (\textcircled{2}). Then, as shown in FIG. 5C, reading (\textcircled{3}) of the color pixels PXc of the pixel array PA is performed after the color integration time Tint_Col elapses and of the depth pixels PXd of the pixel array PA is performed after the depth integration time Tint_Dep, designated as C_RD_PTR and D _RD _PTR. As shown herein, the color integration time Tint_Col is longer than the depth integration time Tint_Dep by a difference ΔTint. Reading, i.e., sensing of the pixel signals POUTc and POUTd, may be sequentially performed from the first row R1 when resetting is performed on the color pixels PXc of the last row Rn.

As shown in FIGS. 5D and 5E, the shuttering unit SHUT repeatedly performs operations of FIGS. 5A through 5C. That is, the first reset unit SHUT1 controls exposure time (integration time) for color pixels (for example, RGB) and the second reset unit SHUT2 controls exposure time for depth pixels. When the image sensor ISEN starts, the first reset unit SHUT1 and the second reset unit SHUT2 having the longest exposure time starts operation first. Here, as the first reset unit SHUT1 has a longer exposure time than that of the second reset unit SHUT2, the first reset unit SHUT1 starts its operation with its exposure time first. After the exposure time of the first reset unit SHUT1 elapses, the color pixel signals POUTc is sampled. Then, the second reset unit SHUT2 starts its operation with its exposure time. After the exposure time of the second reset unit SHUT2 elapses, the depth pixel signals POUTd is sampled.

As above-mentioned, the sample module may sample the color pixel signals POUTc and the depth pixel signals POUTd. Thus, the shuttering unit SHUT may include at least two read shutters (not shown). One read shutter may be control reading about the color pixels and another read shutter may by control reading about the depth pixels. For example, each read shutter may send a row address of a row to be read to the row decoder RD.

As each reset shutter finishes its operation at the end of the pixel array, the reset shutter wraps around and starts operation again from the first row. The first row may be an arbitrary row.

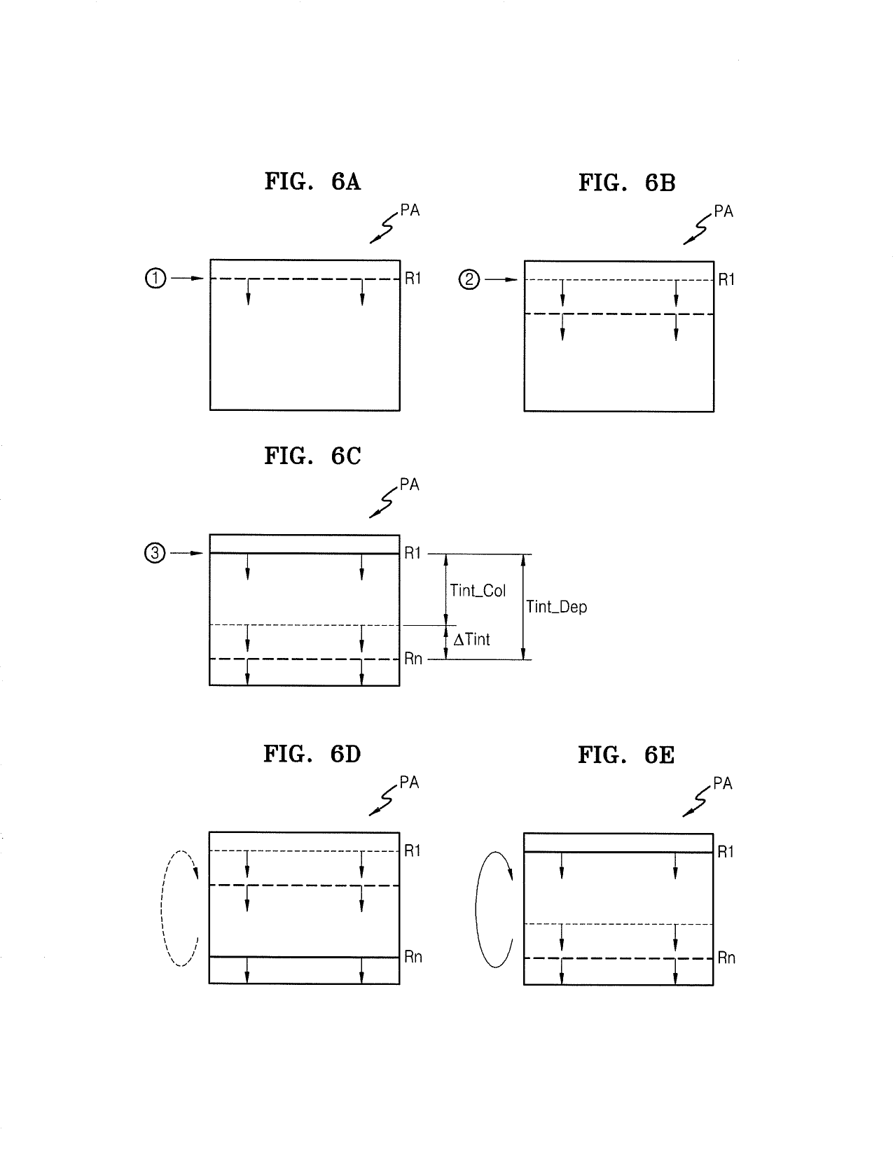

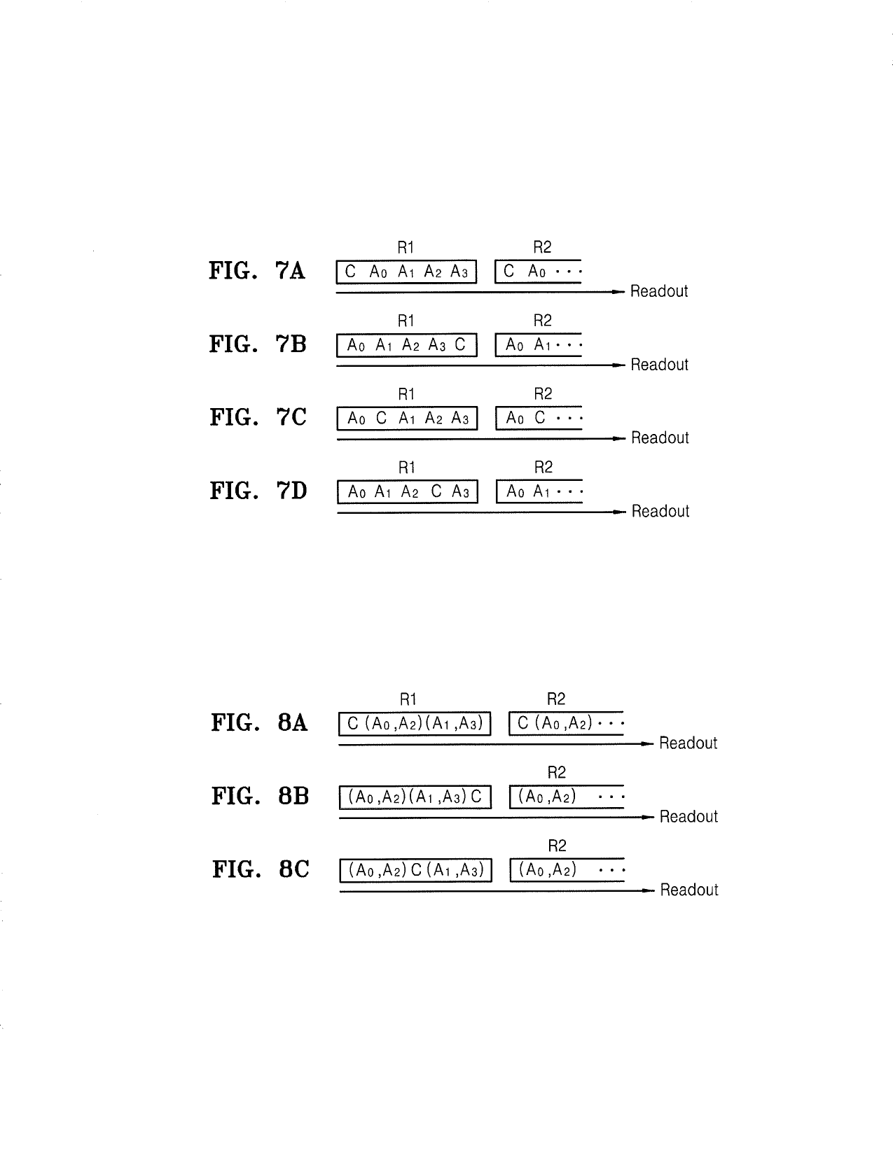

Although the color integration time Tint_Col with respect to the color pixels PXc is longer than the depth integration time Tint_Dep with respect to the depth pixels PXd in FIGS. 5A through 5E, embodiments are not limited thereto. FIGS. 6A through 6E illustrate diagrams of an operation of the shuttering unit SHUT of the image sensor ISEN of FIG. 1 according to another embodiment of the inventive concept.

Referring to FIGS. 6A through 6E, the color integration time Tint_Col with respect to the color pixels PXc may be set to be shorter than the depth integration time Tint_Dep with respect to the depth pixels PXd according to photographing environments. In this case, after the second reset unit SHUT2 starts resetting on the first row R1 as shown in FIG. 6A, the first reset unit SHUT1 may start resetting on the first row R1 as shown in FIG. 6B. Here, the color integration time Tint_Col is shorter than the depth integration time Tint_Dep by a difference ΔTint, as shown in FIG. 6C.

As shown in FIGS. 6D and 6E, the shuttering unit SHUT repeatedly performs operations of FIGS. 6A through 6C. That is, the first reset unit SHUT1 controls exposure time (integration time) for color pixels (for example, RGB) and the second reset unit SHUT2 controls exposure time for depth pixels.

As described above, since the image sensor ISEN according to the one or more embodiments of the inventive concept shuttering on the depth pixels PXd as performed separately from shuttering on the color pixels PXc, i.e., shuttering for the different types of pixels has different integration times, optimal sensing in accordance with photographing environments and characteristics of the color pixels PXc and the depth pixels PXd which sense different light may be performed. Accordingly, the image sensor ISEN of the one or more embodiments of the inventive concept may sense an image with better quality.

The pixel array Pa may include sufficient depth pixels outputting A0˜A3 samples to reconstruct a depth map from one image. For example, 4-tap pixels may be employed, or 1-tap or 2-tap pixels arranged in a mosaic may be employed such that a 4-tap image can be reconstructed. In this case the color and depth frame times equal, Tfc=Tfd. This allows synchronizing capture of depth image with capture of color image, such that both images are output at the same frame rate. Thus, read operations may be performed simultaneously or close to each other in time for the depth and color images. This allows synchronizing depth and color image, such that both images depict the scene at approximately same time, such that differences between images due to motion are minimized.

According to embodiments, the depth integration time Tint_dep=Tfd, such that all reflected light RLIG is sensed without loss. According to embodiments, the color integration time Tint_col<=Tint_dep, such that the exposure of the color image can be controlled as necessary, while all reflected light RLIG is sensed without loss. In cases of overexposure in the depth image the power of the output light OLIG may be controlled instead of decreasing Tint_dep.

When the pixel array PA does not include sufficient depth pixels, such that more than one frame must be captured sequentially in order to compute a single depth map, an embodiment has Tfc=K×Tfd, where K is the number of depth frames may be used in order to compute a single depth map. In this case, the SHUT1 and SHUT2 may read out rows non-simultaneously, such that D_RD_PTR and C_RD_PTR may not be co-located, i.e., simultaneous or nearly simultaneous. For example, if K=4, the depth frame rate Tfd will be 4 times faster than color frame rate Tfc, and the reading and resetting of depth rows may progress from one row to another 4 times faster than the reading and resetting of color rows.

Although shuttering is performed on the entire pixel array PA in FIGS. 5A through 5E, embodiments are not limited thereto. Shuttering units SHUT1 and SHUT2 may start row reset and readout from row RS where S>1 and may end reset and readout at row RE where E<N.

Referring to FIGS. 1, 5A through 5E, 7, and 8, the image sensor may read out pixel data in several ways. If rows of depth and color pixels are sampled simultaneously, the sensor may output depth and color pixel values as a series of interleaved values, as shown in FIGS. 7A to 7D. If rows of depth and color pixels are sampled non-simultaneously, rows of corresponding values are output one at a time after they have been sampled, as shown in FIGS. 8A to 8C. For example, if Tfd=4*Tfc, four rows of depth pixels can be sampled an output, followed by one row of color pixels.

However, embodiments are not limited thereto, and the image sensor ISEN of FIG. 1 may simultaneously output a variety number of depth pixel signals.

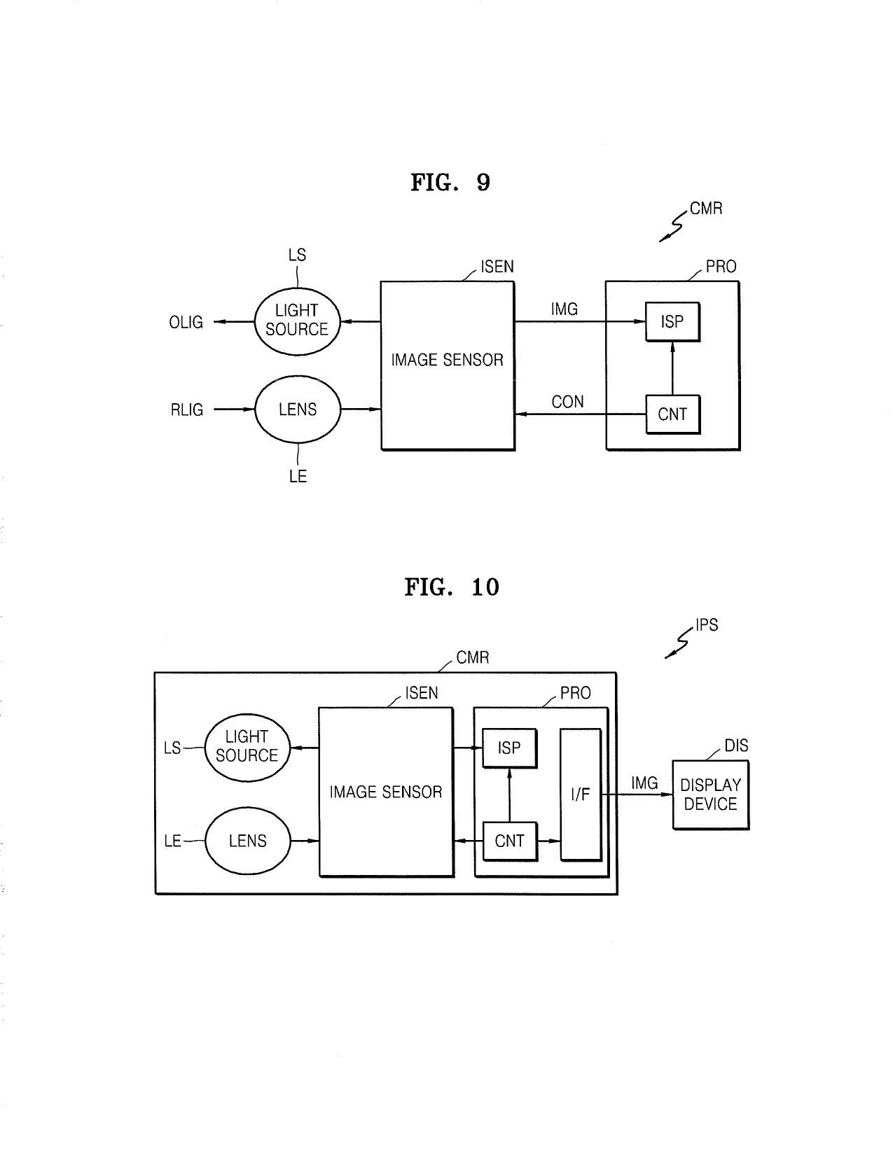

FIG. 9 is a block diagram illustrating an image capturing apparatus CMR according to an embodiment of the inventive concept.

Referring to FIGS. 1 and 9, the image capturing apparatus CMR may include the image sensor ISEN of FIG. 1 that senses image information IMG of the object OBJ from the reflected light RLIG received through the lens LE after the output light OLIG output from the light source LS is reflected by the object OBJ. The light source LS may emit both visible and infrared light. The image capturing apparatus CMR may further include a processor PRO including a controller CNT that controls the image sensor ISEN by using the control signal CON and a signal processing circuit ISP that performs signal processing on the image information IMG sensed by the image sensor ISEN.

FIG. 10 illustrates a block diagram of an image processing system IPS according to an embodiment of the inventive concept.

Referring to FIG. 10, the image processing system IPS may include the image capturing apparatus CMR of FIG. 9 and an apparatus DIS for displaying an image received from the image capturing apparatus CMR. To this end, the processor PRO of FIG. 9 may further include an interface IF through which the image information IMG received from the image sensor ISEN is transmitted to the apparatus DIS.

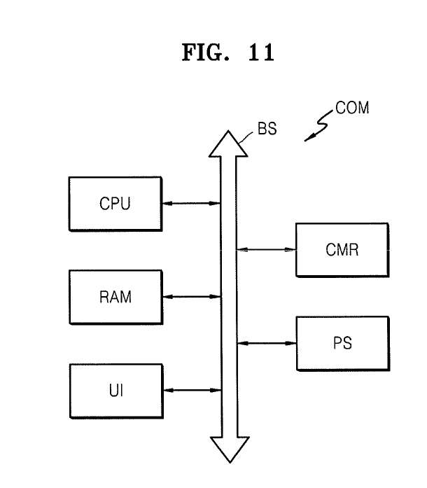

FIG. 11 illustrates a block diagram of a computing system COM according to an embodiment of the inventive concept.

Referring to FIG. 11, the computing system COM includes a central processing unit CPU electrically connected to a bus BS, a user interface UI, and the image capturing apparatus CMR. The image capturing apparatus CMR may include the image sensor ISEN and the processor PRO as described above.

The computing system COM may further include a power supply device PS. Also, the computing system COM may further include a storage device RAM that stores the image information IMG transmitted from the image capturing apparatus CMR.

If the computing system COM is a mobile system, a modem such as a baseband chipset and a battery for supplying an operating voltage of the computing system COM may be additionally provided. Also, since it would be obvious to one of ordinary skill in the art that an application chipset, a mobile DRAM, and the like may be further provided in the computing system COM, a detailed explanation thereof will not be given.

According to the image sensor, the method of sensing an image, and the image capturing apparatus according to the inventive concept, since color information and depth information are sensed in different exposure times, a pixel signal with a sufficient size may be sensed. Accordingly, according to the image sensor, the method of sensing an image, and the image capturing apparatus according to the inventive concept, the quality of a sensed image may be improved.

Example embodiments have been disclosed herein, and although specific terms are employed, they are used and are to be interpreted in a generic and descriptive sense only and not for purpose of limitation. For example, in the above, a method of obtaining a phase delay in consecutive images has been described. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An image sensor for sensing an image of an object by receiving visible light and reflected light that is obtained after output light is reflected by the object, the image sensor comprising:
a pixel array including color pixels that sensed the visible light and depth pixels that sense the reflected light; and
a shuttering unit that facilitates generation of color pixel signals by resetting the color pixels in units of a color integration time and reading the color pixels in units of the color integration time, and facilitates generation of depth pixel signals by resetting the depth pixels in units of a depth integration time that is different from the color integration time and reading the depth pixels in units of the depth integration time.

2. The image sensor as claimed in claim 1, wherein the shuttering unit comprises:
a first reset unit that controls resetting for the color pixels; and
a second reset unit that controls resetting for the depth pixels.

3. The image sensor as claimed in claim 1, wherein the shuttering unit is a rolling shutter that controls the resetting and the reading in units of rows of the pixel array.

4. The image sensor as claimed in claim 3, wherein:
the color integration time is a time taken, after color pixels of an arbitrary row of the pixel array are reset, to read the color pixels of the arbitrary row, and
the depth integration time is a time taken, after depth pixels of an arbitrary row of the pixel array are reset, to read the depth pixels of the arbitrary row.

5. The image sensor as claimed in claim 3, wherein the shuttering unit controls the resetting depth pixels of an arbitrary row of the pixel array, and then color pixels of the arbitrary row.

6. The image sensor as claimed in claim 5, further comprising a sample module that samples the depth pixel signals from depth pixels of an arbitrary row of the pixel array, and after the depth integration time elapses, samples the color pixel signals from the color pixels and the depth pixels of the arbitrary row.

7. The image sensor as claimed in claim 1, wherein the color integration time is longer than the depth integration time.

8. The image sensor as claimed in claim 1, wherein the color integration time is shorter than the depth integration time.

9. The image sensor as claimed in claim 1, further comprising a color information calculator that calculates the color pixel signals as color information of the object.

10. The image sensor as claimed in claim 1, further comprising a depth information calculator that estimates a delay between the output light and the reflected light from the depth pixel signals and calculates depth information of the object.

11. The image sensor as claimed in claim 1, wherein the image sensor is a time-of-flight (TOF) sensor.

12. A method of sensing an image of an object by receiving reflected light obtained after output light is reflected by the object, the method comprising:
outputting reflected light sensed by color pixels of a pixel array of the image sensor for a color integration time, as color pixel signals;
outputting reflected light sensed by depth pixels of the pixel array for a depth integration time that is different from the color integration time, as depth pixel signals; and
calculating the color pixel signals and the depth pixel signals as image information of the object.

13. The method as claimed in claim 12, wherein outputting the color pixel signals comprises resetting the color pixels in units of the color integration time and reading the reset color pixels in units of the color integration time.

14. The method as claimed in claim 13, wherein outputting the depth pixel signals comprises resetting the depth pixels in units of the depth integration time and reading the reset depth pixels in units of the depth integration time.

15. The method as claimed in claim 13, wherein the color integration time is longer than the depth integration time.

16. The method as claimed in claim 13, wherein the color integration time is shorter than the depth integration time.

17. An image sensor for sensing an image of an object by receiving visible light and reflected light that is obtained after output light is reflected by the object, the image sensor comprising:
a pixel array including first pixels and second pixels that sense the visible light or different wavelengths of the reflected light; and
an integration control unit that reads the first pixels in units of a first integration time and reads the second pixels in units of a second integration time, different from the first integration time.

18. The image sensor as claimed in claim 17, wherein the first pixels are color pixels sensing the visible light and the second pixels are depth pixels sensing the reflected light.

19. The image sensor as claimed in claim 18, wherein the depth pixels output a plurality of depth pixel signals for each frame.

20. The image sensor as claimed in claim 18, wherein the depth pixels sense infrared light.
